(19) United States
(12) Patent Application Publication
(10) Pub. No.: US 2006/0253900 A1
(43) Pub. Date: Nov. 9, 2006

(54) Client assisted firewall configuration

(75) Inventors: Michael Paddon, Kellyville (AU); Philip Michael Hawkes, Ashfield (AU); Gregory Gordon Rose, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/315,394

(22) Filed: Dec. 21, 2005

Related U.S. Application Data
(60) Provisional application No. 60/638,271, filed on Dec. 21, 2004.

(51) Int. Cl. G06F 15/16

(52) U.S. Cl. 726/11

(57) ABSTRACT

Embodiments describe techniques in connection with configuring a firewall and/or reducing network traffic. According to an embodiment is a method for configuring a firewall to reduce unwanted network traffic. The method includes executing a web-server and detecting a passive socket has been created. The method also includes establishing contact with a firewall and requesting the firewall to permit flows directed to the passive socket. According to some embodiments, the method can include closing the web-server and destroying the passive socket. The firewall can be contacted with the destroyed passive socket information and can be sent a request to deny flows directed to the destroyed passive socket. If the passive socket is closed, the method can automatically revoke the request to the firewall to permit flows directed to the passive socket.

### CROSS-REFERENCE TO RELATED APPLICATIONS

This application claims the benefit of U.S. Provisional Application Ser. No. 60/638,271, filed Dec. 21, 2004, entitled “CLIENT ASSISTED FIREWALL CONFIGURATION,” the entirety of which is incorporated herein by reference.

### BACKGROUND

I. Field

The following description relates generally to data communication and more particularly to firewall configuration and reduction of network traffic.

II. Background

Firewalls are security devices that protect networks from unauthorized access and malicious attacks. Such unauthorized access may be to obtain sensitive information or disrupt the function of a network. A traditional firewall divides a network into two portions, an internal portion, which is behind the firewall, and an external portion, which is outside the firewall. To protect against unauthorized access, firewalls can inspect packets and sessions and make a determination whether such packets and session should be transmitted to the intended destination or whether they should be blocked or dropped.

The firewall is typically located at the point of entry and scans incoming traffic by comparing the traffic to predetermined criteria. Traffic not matching the predetermined criteria is blocked or discarded. The predetermined criteria can include parameters, such as port number, application IDs, source, destination, content filters, IP address, machine names, and TCP/IP flags, as well as other parameters depending of the complexity that can be tolerated and the degree of protection desired. The number of parameters to be matched to make a determination whether to pass or reject a packet establishes a granularity of protection. A firewall having a coarse granularity may inadvertently block desired incoming traffic because such traffic was deed undesired, while at the same time it may not be adequate to protect against undesired traffic.

A security policy can be defined and/or enforced by a network administrator at a central point. Users might not be able to choose which traffic is enabled and/or disabled for their terminals even though different users might have different network access preferences and needs. Different users may want to engage in different types of traffic flows. These flows are affected by the network's security policy. For example, one user may want to block transmissions from a particular Transmission Control Protocol/Internet Protocol (TCP/IP) network address, while another user would like to receive those transmissions. One user may want transmissions from a particular subnet address of a network while another user wants all transmissions form the network address. Other users may want message traffic destined for a particular port or application while a different user may want to block all incoming connections and only allow outgoing connections.

The firewall operates as a gatekeeper. Firewalls local to each device place a firewall around each terminal or mobile device. In this situation, unauthorized packets are not dropped until the packets reach a terminal or mobile device. Thus, network bandwidth, which is valuable in a wireless network, is wasted because the packet has already consumed the wireless resources needed to transmit the packet. These wasted resources could be better utilized by being allocated to other connections. Wasted resources can increase user costs by increasing message transmissions and can slow overall throughput because of the resources utilized to transmit the packet over the wireless links.

To overcome the aforementioned as well as other deficiencies, what is needed is a technique to block unwanted or unintended packets before transmission to a device to reduce network traffic. What is also need is a technique to provide a device the ability to dynamically modify one or more policy of a firewall to allow device to specify specific packets, senders, and/or other packet criteria. The configured firewall can be remote from the communication end point or device. The ability to automatically revoke a firewall policy during a communication is also needed to provide protection.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with configuring a firewall and/or reducing network traffic. According to an embodiment is a method for a mobile device to configure a firewall to reduce unwanted network traffic. The method includes establishing a network connection with a network firewall and communicating with the network firewall to manage network traffic. According to some embodiments, the method can include detecting if a passive socket has been created and requesting the network firewall to permit flows directed to the network socket. In some embodiments, the method can include closing a web-server and destroying the passive socket. The firewall can be contacted with the destroyed passive socket information and can be sent a request to deny flows directed to the destroyed passive socket. If the passive socket is closed, the method can automatically revoke the request to the firewall to permit flows directed to the passive socket.

According to another embodiment is a method for a host to automatically recover from a broken or terminated session. The method includes requesting a remote firewall to allow transit of packets directed to at least one open socket, detecting a broken session, and revoking the packet request directed to at least one open socket. The method can further include reestablishing a new session and requesting transit of desired flows. According to some embodiments, requesting packets directed to at least one open socket could include generating a list of current open sockets.

According to another embodiment is a mobile device for configuring a network firewall. The mobile device includes a processor that analyzes information related to configuring a firewall to reduce traffic and a memory operatively connected to the processor. The mobile device can also include an establisher that establishes a communication with an external source and a designator that designates parameters associated with a packet received from the external source and communicates the parameters to a firewall. Also included in the mobile device can be an invalidator that requests revocation of transit for the at least one parameter. In some embodiments, mobile device can include a transmitter that communicates to a firewall at least one policy update and a receiver that receives an acknowledgement or denial of the policy from the firewall.

According to another embodiment is an apparatus for reducing network traffic. The apparatus can include means for detecting at least one firewall, means for communicating with the at least one firewall, and means for dynamically updating a policy associated with the at least one firewall. The apparatus can also include means for inspecting a list of passive sockets or means for specifying desired incoming flows.

According to a further embodiment is a computer readable medium of a handset having computer-executable instructions for establishing a network connection and detecting a passive socket associated with the established network connection. The instructions can further include contacting a firewall and requesting the firewall to allow flows directed to the passive socket. According to some embodiments, the instructions can include terminating the network connection, destroying the passive socket, contacting the firewall, and requesting the firewall to deny flows directed to the destroyed passive socket.

According to another embodiment is a processor of a handset that executes instructions for dynamically updating a firewall policy. The instructions can include detecting at least one firewall, communicating with the at least one firewall, and dynamically updating a policy associated with the at least one firewall. The process may also include instructions for automatically revoking the policy at substantially the same time as a session is broken.

According to another embodiment is a handset that dynamically configures a firewall. The handset includes an initializer that establishes a session with a firewall, a designator that designates at least one flow and communicates the at least one flow to a firewall and an invalidator that can revoke transit of the least one flow. According to some embodiments, the designator can specify a parameter associated with at least one packet or request a packet from one or more senders. The invalidator, according to some embodiments, can revoke transit of at least one packet, rescind a request for a packet from one or more senders, revoke a transit automatically based on at least one packet parameter, or revoke a transit based on a user input.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a block diagram of a communication system that utilizes firewall technology.

FIG. 2 illustrates a system for client assisted firewall configuration.

FIG. 3 illustrates a system for automatically and dynamically configuring a firewall policy.

FIG. 4 illustrates a system for automatically and dynamically configuring a firewall policy.

FIG. 5 illustrates a system for configuring a firewall and reducing network traffic.

FIG. 6 is a flow diagram of a methodology for dynamically permitting the transit of legitimate incoming data flows.

FIG. 7 is a flow diagram of a methodology for automatic recovery of data flows.

FIG. 8 is a flow diagram of a methodology for automating firewall protection and reducing network traffic.

FIG. 9 illustrates a conceptual block diagram of a configuration of a terminal.

### GLOSSARY OF TERMS

Firewall—device that only permits packets that satisfy a “security policy” to enter or leave a network.

Host—network node that utilizes the network as a packet transport medium. In a mobile device network, these hosts would typically be handsets or wireless enabled computers.

Flow—bidirectional exchange of packets between two distinct entities.

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a user device. A user device can also be called a system, a subscriber unit, subscriber station, mobile station, mobile device, host, handset, remote station, access point, base station, remote terminal, access terminal, user terminal, terminal, user agent, or user equipment. A user device can be a cellular telephone, a cordless telephone, a Session Initiation Protocol (SIP) phone, a wireless local loop (WLL) station,. a personal data assistant (PDA), a handheld device having wireless connection capability, or other processing device(s) connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips...), optical disks (e.g., compact disk (CD), digital versatile disk (DVD) . . . ), smart cards, and flash memory devices (e.g., card, stick, key drive . . . )

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used.

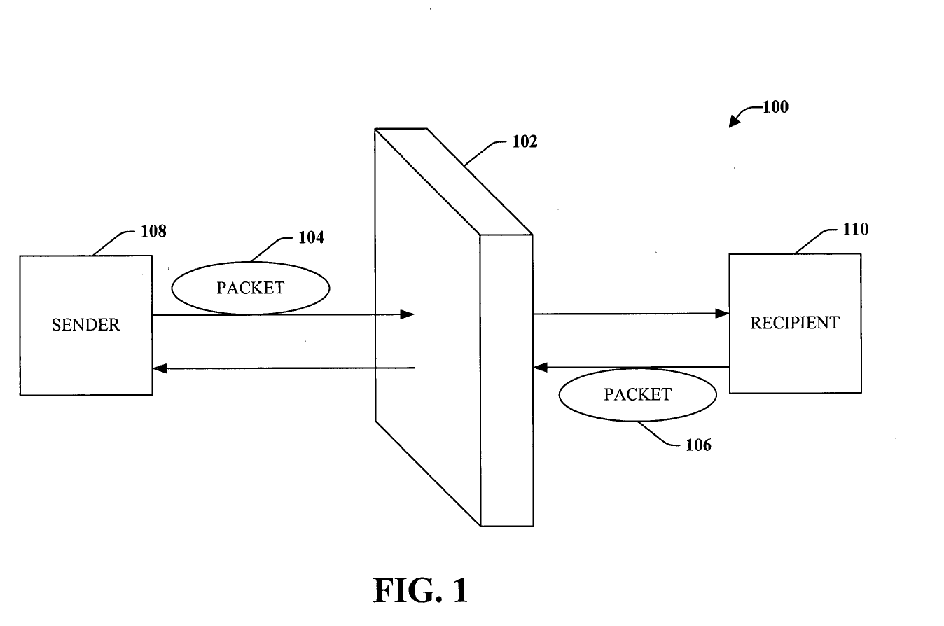

With reference now to the drawings, FIG. 1 illustrates a block diagram of a communication system 100 utilizing firewall technology that can be implemented with a portable device or terminal, a portable (mobile) phone, a personal data assistant, a personal computer (desktop or laptop), or other electronic and/or communication devices. System 100 includes a firewall 102 that filters incoming and/or outgoing data, referred to as a data or network packet 104 and 106. Firewall 102 can be a firewall operating on a network operator, an infrastructure equipment, etc. Packet 104 and 106 can be any type of communication, including a group of data, sent and/or communicated from one device to another device. Firewall technology inspects each packet (incoming data), classifies each packet, and performs one or more actions based on such inspection and/or classification. Typical actions are to pass, block, and/or route the packet in a specific manner. Stateful packet filters may also take into account previously seen packets when performing classification.

For example, purposes and not limitation, firewall 102 may allow a data packet(s) 104 sent from a sender 108, located on one side of firewall 102, to be transmitted to a recipient 110, located on the other side of firewall 102. Packet(s) 104 conveyed by sender 108 that are intended and/or authorized to reach recipient 110 are relayed or allowed to pass through firewall 102. Packet(s) 104 not intended and/or not authorized for such recipient 110 can be blocked by firewall 102 and not relayed to recipient 110. In such a way, recipient 110 is unaware of and does not receive unwanted packets and/or packets unintended for such recipient 110.

Recipient 110 can be configured to communicate with firewall 102 to provide a set of rules of policies regarding sender(s) 108 and/or packet(s) 104 that the recipient 110 would like firewall 102 to allow and those that recipient 110 would like firewall 102 to block. In such a manner, recipient 110 is acting as a server. In other words, recipient 110 may want external sender 108 to contact recipient 110. Thus, recipient 110 can be configured to communicate directly with firewall 102 to update a policy or policies in a dynamic manner.

Recipient 110 can further be configured to automatically determine which incoming flows or packets 104 are desirable by inspecting a list of passive sockets. For example, recipient 110 can open or create a passive socket to act as a server. Recipient 110 notifies firewall 102 that packets 104 intended for this socket are to be transmitted to recipient 110. If recipient shuts down or closes contact with the web server, the passive socket previously created is destroyed. Receiver 1 10 can notify firewall 102 of the passive socket destruction and request firewall 102 to deny all further traffic intended for that passive socket.

Recipient 110 can also relay packets 106 to sender 108 through firewall 102. In such a manner, recipient 110 is acting as a client and firewall 102 can block packet 106 or allow packet 106 to be communicated to sender 108 according to various protocol and techniques. For example, firewall 102 may allow or deny such packets 106 based on criteria predetermined by a network provider, for example. Firewall 102 may also route the packet 106 depending on a policy established by the intended recipient of that packet, which in this case is the sender 108. Thus, firewall 102 can maintain a different set of rules or policies for different devices.

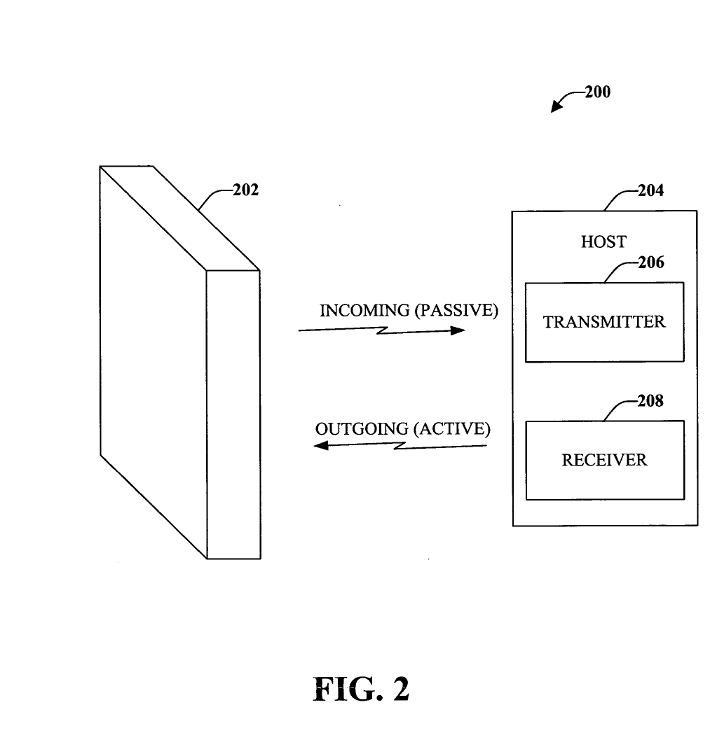

FIG. 2 illustrates a system 200 for client assisted firewall configuration. System 200 includes a firewall 202 and a host 204 (e.g., mobile device) that can be in wireless communication. Host 204 can be, for example, cellular phones, smart phones, laptops, handheld communication devices, handheld computing devices, satellite radios, global positioning systems, PDAs, and/or other suitable devices for communicating over wireless network 200. Although a number of firewalls(s) 202 and hosts(s) 204 can be included in system 200, as will be appreciated, a single firewall 202 that transmits communication data signals to a single host 204 is illustrated for purposes of simplicity.

Host 204 includes a transmitter 206 through which host 204 can initiate a data flow or communication session and/or request updates to a policy maintained by firewall 202. Host can also include a receiver 208 through which host 204 can receive acknowledgement or denial of the policy from the firewall 202 and/or can receive a data flow or packet.

Host 204 can respond to transmitted packets from the firewall 202 through transmitter 206. When host 202 initiates a data flow, it is acting similar to a client and is considered “active”. When host 202 is responding to a data flow, it is acting similar to a server and is considered “passive”. An active flow is considered as outgoing and a passive flow is incoming.

When host 204 is acting as a server, host 204 can communicate directly with firewall 202 and manipulate firewall rules. For example, host 204 can notify firewall 202 of particular communications, senders, etc. from which host 204 desires to receive communication. Host 204 can automatically notify firewall 202 of any broken sessions or terminated sessions and revoke the policy of such sessions, whereby firewall 202 will block the sessions and not allow them to be transmitted to host 204. By configuring firewall 202 in such a manner, the packets intended for host 204, but which are not desired by host 204 are blocked before they are sent. This reduces network traffic because such packets are not sent and then discarded by host 204. Instead, the determination is made at the firewall 202, before the packets are transmitted to host 204.

Host 204 can include a decoder component (not shown) that can decode a received signal and/or data packet therein for processing. Upon successful decode of a data packet, an acknowledgment component (not shown) can generate an acknowledgment that indicates successful decode of the data packet, which can be sent to firewall 202 to inform a sender of the communication (not shown) that the data packet was received and decoded, and therefore need not be retransmitted.

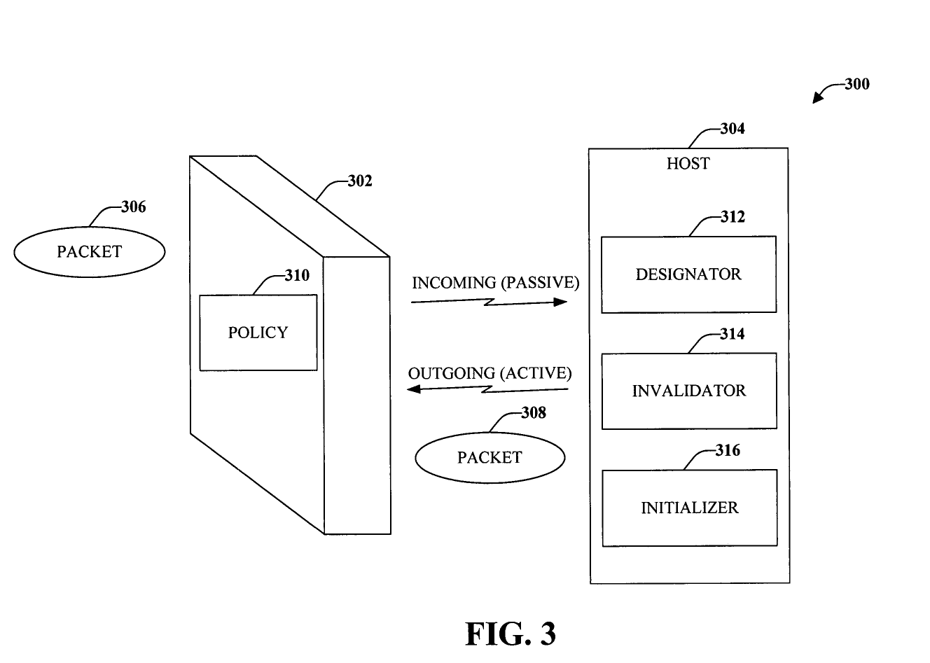

FIG. 3 illustrates a system 300 for automatically and dynamically configuring a firewall policy. System 300 includes a firewall 302 that can be included in a network infrastructure and a host 304 (e.g., mobile device). Host 304 can receive incoming packets of data 306 or can initiate outgoing packets of data 308. When receiving incoming packets 306, host is operating in a passive mode and is acting similar to a server. When initiating and sending outgoing packets 308, host 304 is in an active mode and operates similar to a client. In either the incoming mode or the outgoing mode, the data packets 306 and 308 generally should pass through firewall 302. Based on a set of rules or a policy 310, firewall 302 can block, pass, or redirect a packet 306 and 308.

Host 304 can include a designator 312, an invalidator 314, and an initializer 316, which can be functional blocks that represent functions implemented by a processor, software or combination thereof (e.g., firmware). Designator 312, invalidator 314, and/or initializer 316 can communicate directly with firewall 302 or they may communicate through a transmitter (not shown) and receive communication through a receiver (not shown). When a packet 306 is communicated to firewall 302, intended for host 304, firewall 302 can make a determination whether the packet 306 should be transferred to host 304, or blocked. Such a determination can be based upon a pre-determined policy 310. The policy can include various criteria such as permitted flow endpoints, resource limitations, etc. In some embodiments, the policy 310 can be dynamically altered or modified by host 304 through a selective enforcement technique.

Designator 312 can be configured to designate parameters associated with a packet 306 that host 304 would like to receive and communicate such parameters to firewall 302. Such parameters may be subject to policy 310 constraints. Host 304 can request transit of specified incoming flows (e.g., packets 306). Flows can be specified by designator 312 by a set of criteria that should match (or not match) some or all of the fields available in a packet's header, for example. A packet generally includes a header and may have higher layer protocol headers (e.g., Internet Control Message Protocol (ICMP), User Datagram Protocol (UDP), and/or Transmission Control Protocol (TCP) etc.). The criteria or parameters specified by designator 312 can include, but is not limited to, exact values, value lists, value ranges, open sockets, and the like.

Invalidator 314 can be configured to request revocation of transit for specified flows or for all flows that host 304 has requested. For example, designator 312 may request that a packet of one or more types and/or from one or more senders should be transmitted to host 304. If, after requesting the transmission of such packets, it is determined that the packets are no longer desirable, the invalidator 314 can revoke the request of certain packets. This revocation can be performed automatically and autonomously by system 300 based on certain parameters (e.g., size of packet, type of packet, or other criteria).

The revocation can also be based upon a manual input received from a user of host 304. For example, packets may be specified as being intended for user. However, user may decide that such packets are no longer desirable for a variety of reasons. User can manually revoke such packets through an interface associated with host, such as invalidator 314.

Host 304 can provide various types of user interfaces. For example, host 304 can provide a graphical user interface (GUI), a command line interface, and the like. For example, a GUI can be rendered that provides a user with a region or means to load, import, read, etc. parameter information, packets blocked, senders blocked and/or a system query prompting whether user desires such packets/senders to be blocked. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

In an example, a command line interface can be employed. For example, the command line interface can prompt (e.g., by a text message on a display and an audio tone) the user for information by providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

The protocol regularly exchanges packets in both direction (incoming and outgoing), thus, both host 304 and firewall 302 can become aware of a broken session in a timely manner. For example, firewall 302 and/or host 304 can make a determination whether the session is broken based on lack of traffic from a peer (e.g. other mobile device, other communication device, ...). The determination based on the broken session can be included as part of the protocol itself. In some embodiments, the determination can be supplied by an underlying transport, such as Transmission Control Protocol (TCP) keep-alive segments.

If it is determined that a session is broken or is terminated, the flows previously requested by the host 304 can be automatically revoked. In such a manner, all packets intended for host 304 are automatically blocked by firewall 302 and are not allowed to be passed to host 304. Thus, the broken session and/or incomplete packets are not communicated along the air interface and do not occupy scarce and valuable resources.

The following is for example purposes and not limitation. Handset or host 304 can execute a web-server, creating a passive socket listening on TCP port 80. A firewall control component (e.g., designator 312) can detect that a passive socket on TCP port 80 has been created. Control component establishes contact with firewall 302 and requests firewall 302 to permit flows destined for the handset's TCP port 80 to be granted transit. Firewall 302 can either acknowledge or deny the request. External parties can initiate incoming flows that contact the handset's web server. Some time later, the web server on the handset can shut down, destroying the passive socket on TCP port 80. At substantially the same time or at a substantially different time, the firewall control component on the handset can detect the destruction of the passive socket. The control component can establish contact with the firewall and request the firewall to deny all further inbound traffic to the handset on TCP port 80. It should be understood that in IP based networks, the process can be substantially different than that described above because both flows and topology are bound to end point addresses.

To initiate a new session or to recover from a broken session and subsequent automatic revocation of data flows, host 304 can establish a session through initializer 316. Initializer 316 can be configured to determine which firewall 302 host 304 is in communication with since host 304 can be a mobile device and may move from one geographic region or cell to another region or cell. As the device is moved, it may need to establish contact with one or more firewalls. Initializer 316 can be configured to communicate with designator 312 and request (or re-request in the case of a broken session) transit of desired flows.

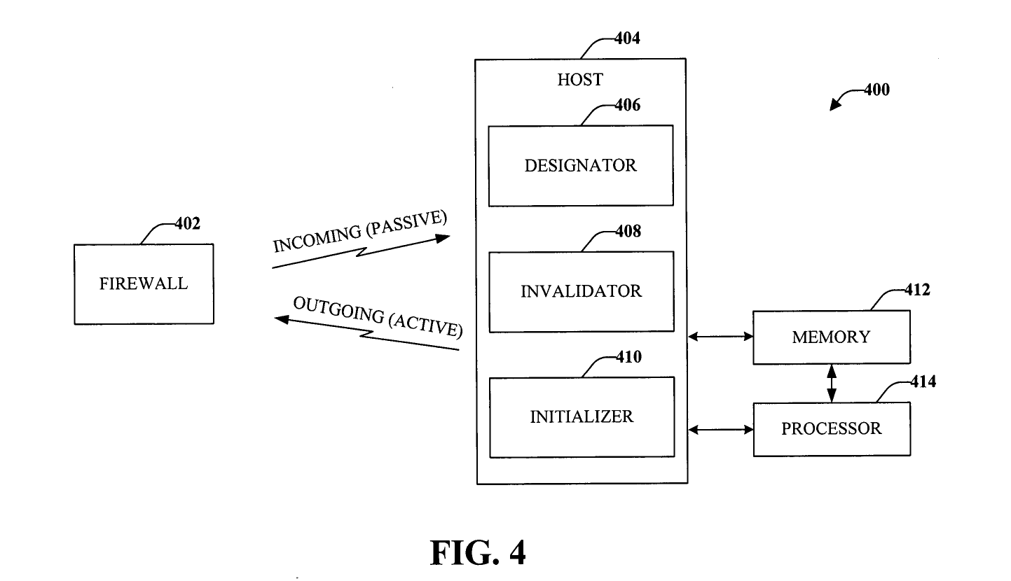

FIG. 4 illustrates a system 400 for automatically and dynamically configuring a firewall policy. System 400 includes a firewall 402 configured to transmit, block, or reroute incoming packets and/or outgoing packets. Also included is a host 404 that can include a designator 406, an invalidator 408, and an initializer 410. Host 404 operates in a passive mode for incoming packets and in an active mode for outgoing packets. System 400 operates similar to system 300 illustrated and described with reference to FIG. 3.

System 400 can include memory 412 operatively coupled to host 404. Memory 412 can store information related to requested incoming flows, matching criteria, specified flows, revoked flows, open network sockets, etc. related to configurable firewall technology and reducing traffic in a wireless communication system. A processor 414 can be operatively connected to host 404 (and/or memory 412) to analyze information related to configurable firewall technology and reducing traffic in a wireless communication system. Processor 414 can be a processor dedicated to analyzing information received by host and/or generating information to be sent by host 404, a processor that controls one or more components of system 400, and/or a processor that both analyzes and generates information received by host 404 and controls one or more components of system 400.

Memory 412 can store protocols associated with desired packets, packet flows, senders, communication types, etc. and take action to control communication between host and firewall 402, etc., such that system 400 can employ stored protocols and/or algorithms to achieve a reduction in communication traffic in a wireless network as described herein. It should be appreciated that the data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (DRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 412 of the disclosed embodiments is intended to comprise, without being limited to, these and other suitable types of memory.

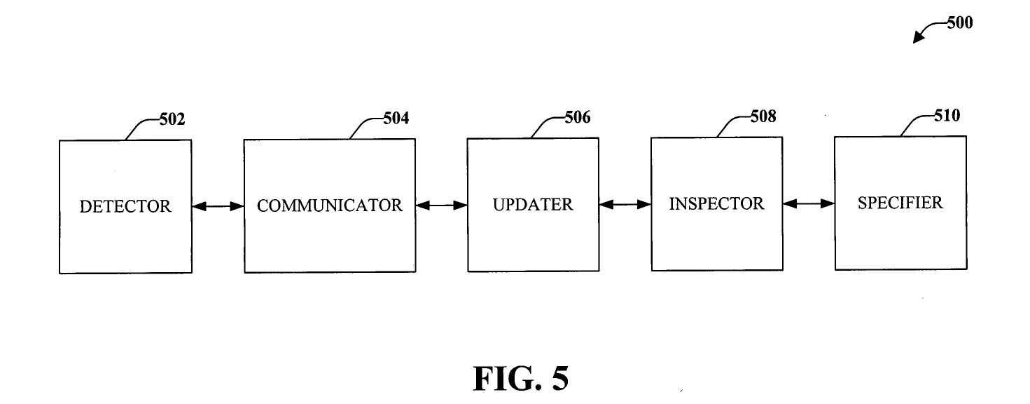

FIG. 5 illustrates a system 500 for configuring a firewall and reducing network traffic. Illustrated are blocks that can be functional blocks that represent functions implemented by a processor, software or combination thereof (e.g., firmware). System 500 can include a detector 502 that can detect one or more firewalls included in a network. A communicator 504 can be configured to communicate with the detected firewall. Such communication can include, but is not limited to, requesting establishment of a session, specifying transit of specified incoming flows, revoking one or more incoming flows, or other types of communication. Also included in system 500 can be an updater 506 that can be configured to update a policy associated with the firewall. Updating the policy can include changes to an existing policy as automatically determined by system 500 or changes that are manually input to system 500 by a user.

In some embodiments, system 500 can also include an inspector 508 and a specifier 510. Inspector 508 can be configured to inspect a list of open network sockets, which may be open passive network sockets. Specifier 510 can be configured to generate a suitable request to the firewall when a passive socket is listened on and can generate a revocation when a passive socket is closed. If system 500 is recovering from a broken or terminated session, the current list of passive sockets may be enumerated to generate suitable requests.

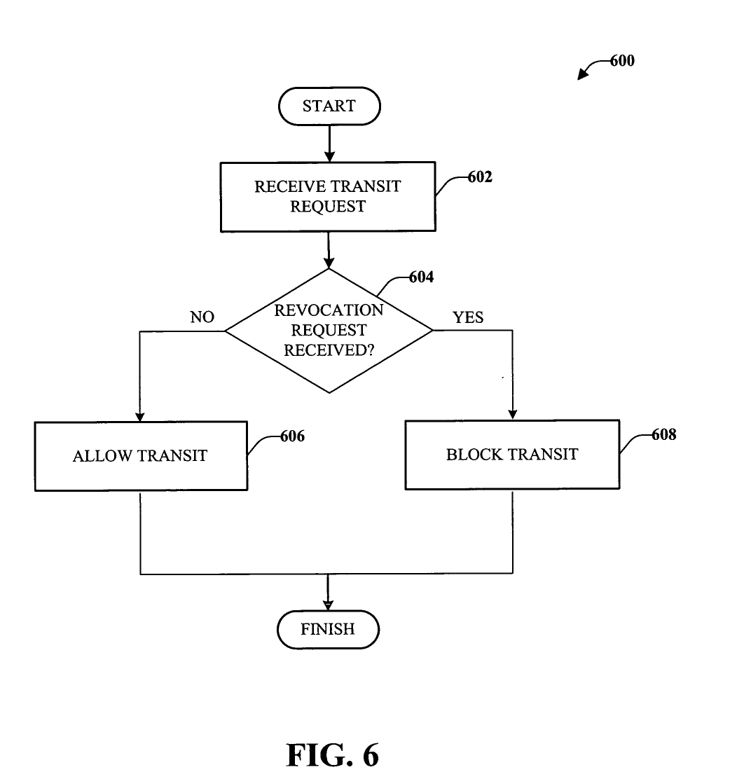

In view of the exemplary systems shown and described above, methodologies, which may be implemented in accordance with one or more aspects of the various embodiments, will be better appreciated with reference to the diagrams of FIGS. 6-8. While, for purposes of simplicity of explanation, the methodologies are shown and described as a series of acts (or function blocks), it is to be understood and appreciated that the methodologies are not limited by the order of acts, as some acts may, in accordance with these methodologies, occur in different orders and/or concurrently with other acts from that shown and described herein. Moreover, not all illustrated acts may be required to implement a methodology in accordance with one or more aspects of the disclosed embodiments. It is to be appreciated that the various acts may be implemented by software, hardware, a combination thereof or any other suitable means (e.g. device, system, process, component) for carrying out the functionality associated with the acts. It is also to be appreciated that the acts are merely to illustrate certain aspects presented herein in a simplified form and that these aspects may be illustrated by a lesser and/or greater number of acts. Moreover, not all illustrated acts may be required to implement the following methodologies. Those skilled in the art will understand and appreciate that a methodology could alternatively be represented as a series of interrelated states or events, such as in a state diagram.

FIG. 6 is a flow diagram of a methodology 600 for dynamically permitting the transit of legitimate incoming data flows. Legitimate incoming flows are those that a device has previously requested. For example, a device may know or infer based on flows previously received that if it receives a particular type of traffic, traffic from a specific source, etc. that the flow will be discarded or receipt of the traffic will be denied upon receipt at the device. The device may also have this information based on user-specified parameters. Rather than waiting until these undesired and/or unintended flows are received at the device, the device can identify these flows (e.g., type, source, etc.) before that flow is sent to the device, taking up valuable bandwidth and resources.

The method 600 starts at 602 where a transit request is received. This transit request can include information regarding only those types, sources, etc. from which mobile device desires to receive communication. This information can be predefined by device and maintained at a network periphery or firewall. The traffic flows for which the transit request has been received will be transmitted to the device. Traffic flows for which a transit request has not been received will be blocked before being further transmitted to device.

Flows can be specified by various criteria and the flow should match the criteria to be transmitted. In some embodiments, the various criteria can be information for which the flow should not match. For example, the criteria may be some or all of the fields available in a packet's header(s). A header is a portion of a message that contains information that will guide the message to the correct destination. Included in the header can be a sender address, a receiver address, a precedence level, routing instructions, synchronization pulses, etc. An IP packet can have higher layer protocol headers such as Internet Control Message Protocol (ICMP), User Datagram Protocol (UDP), and/or Transmission Control Protocol (TCP). The criteria may consist of exact values, value lists, and/or value ranges.

At 604, a determination is made whether a revocation request has been received. The revocation request can be for a specified flow or flows or it can be for all flows that were previously requested. If the determination at 604 is that a revocation request was not received (“no”), the method 600 continues at 606 and the flow is allowed transit through to the device. If the determination at 604 is that a revocation request has been received (“yes”), the method 600 continues at 608 and the transit is blocked before sending to the device.

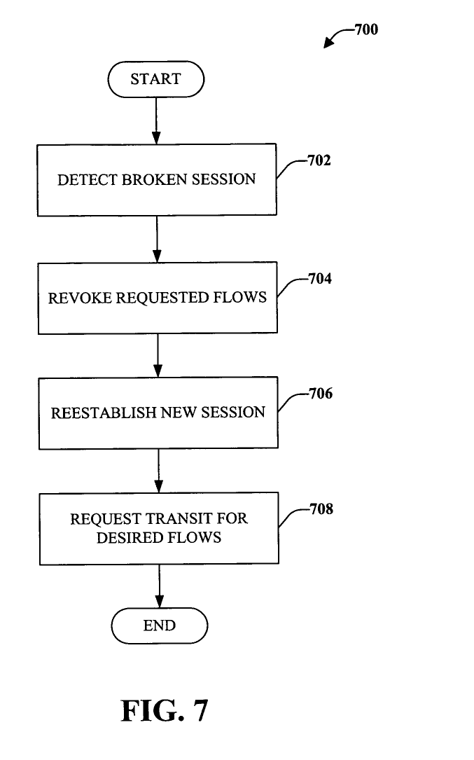

In the above methodology 600, the transit request and revocation of requested flows may be received at a network firewall from a mobile device (e.g., handset). The network firewall can allow or block the transit of incoming data flows based on whether the network firewall received a transit and/or revocation request from the mobile device. [00661 FIG. 7 is a flow diagram of a methodology 700 for automatic recovery of data flows. The automatic recovery is provided for situations where a session, which was established by requesting a remote firewall to allow transit of packets directed to at least one open socket, may become broken, interrupted, or terminated due to a variety of reasons. At 702, a broken session is detected by a host and/or a firewall. Since the protocol regularly exchanges packets in both directions (e.g., incoming, outgoing) both host and firewall can become aware of a broken session in a timely manner, and in most situations at substantially the same time as the occurrence of the broken session. Such awareness can be a result of observing a lack of traffic from a peer device. This can be performed as part of the protocol itself, or it can be supplied by an underlying transport (e.g., TCP keep-alive segments).

When a session is broken or otherwise terminated, the flows requested by the associated host are revoked, at 704. By revoking the requested flows, the integrity and confidentiality of the host are protected. Thus, no traffic is allowed to be transmitted to the host, and such traffic is block before being sent to the device and taking up bandwidth.

According to some embodiments, if the host desires to recover the data flows, a new session can be reestablished at 706. This new session can be based on a new request, or it can be based on the reestablishment of a list of passive sockets to generate suitable requests. A request (or re-request) or transit of desired flows is established at 708.

In the above methodology 700, for example, an apparatus (e.g., mobile device) can detect a broken session and contact a network firewall to revoke requested flows. If desired (e.g., by a user), the apparatus can reestablish a new session with the firewall and request transit of desired flows.

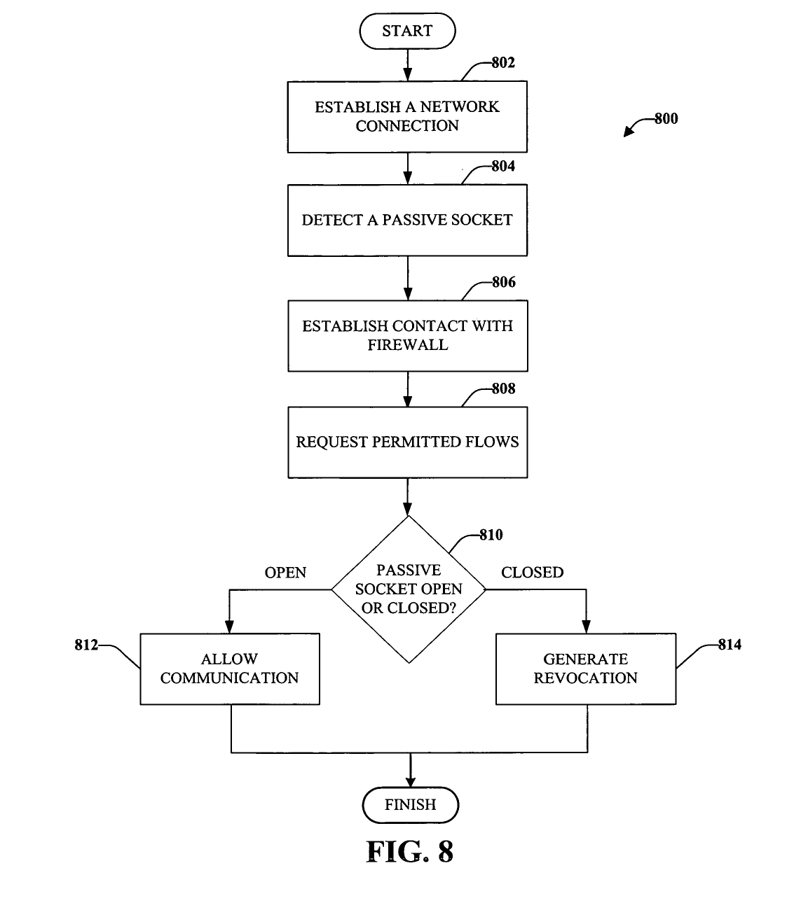

FIG. 8 is a flow diagram of a methodology 800 for automated firewall protection and reducing network traffic. The network traffic that is reduced can included unwanted and/or unintended traffic, broken sessions, terminated sessions, and the like. At 802, a handset desires to receive an incoming communication flow and operates in a passive mode or as a server. Handset creates a passive socket, at 804. This passive socket can be on a TCP port 80, for example. In some embodiments, the passive socket can be included in a listing of open passive sockets, which is periodically or continuously monitored for changes, modifications, and the like. Contact or communication with a firewall is established at 806. The contact or communication can be triggered when the passive socket is created. The communication can include, at 808, a remote firewall policy update such as a request that the firewall permit flows directed to the passive socket. The communication may also include a list of passive network sockets generated by one or more open session. This list can further include those services for which a host is aware of and which host is offering at any given time.

Incoming flows, initiated by external parties, directed to the one or more listed open passive sockets, can be allowed transit by the firewall. If the web server shuts down or is terminated, the passive socket on TCP port 80 is destroyed. A determination is made, at 810, whether the passive socket is open or closed (e.g., terminated or destroyed). If the socket is open (“yes”), the external party packets, flows, communications, etc. are allowed to be transmitted or continue transmission at 812. If the determination at 810 is that the socket is closed (“no”), a revocation request is generated, at 814. This revocation request can be sent automatically upon detection that the socket is closed. This request can include an instruction to the firewall to deny all further inbound traffic to TCP port 80. When recovering from a broken or terminated session, the current list of passive sockets may be enumerated to generate suitable requests.

In the above methodology 800, for example, a mobile device can establish the network connection, detect an open passive socket, establish contact with the firewall and request permitted flows. The mobile device can further make the determination whether the passive socket is open or closed and, if closed, generate a revocation request to the firewall.

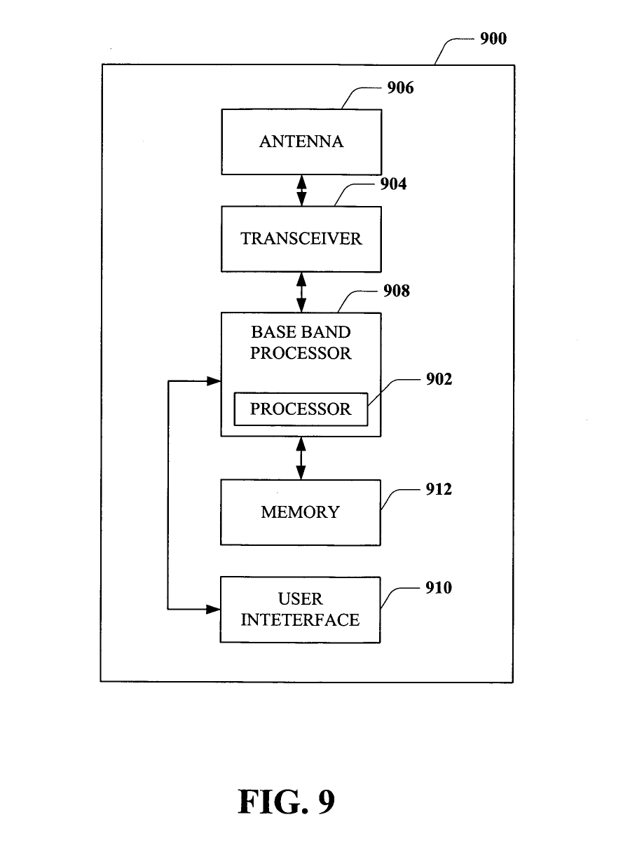

With reference now to FIG. 9, illustrated is a conceptual block diagram of a possible configuration of a terminal 900. As those skilled in the art will appreciate, the precise configuration of the terminal 900 may vary depending on the specific application and the overall design constraints. Processor 902 can implement the various embodiments disclosed herein. Terminal 900 can be implemented with a front-end transceiver 904 coupled to an antenna 906. A base band processor 908 can be coupled to the transceiver 904. The base band processor 908 can be implemented with a software based architecture, or any other type of architecture. A microprocessor can be utilized as a platform to run software programs that, among other functions, provide control and overall system management function. A digital signal processor (DSP) can be implemented with an embedded communications software layer, which runs application specific algorithms to reduce the processing demands on the microprocessor. The DSP can be utilized to provide various signal processing functions such as pilot signal acquisition, time synchronization, frequency tracking, spread-spectrum processing, modulation and demodulation functions, and forward error correction.

Terminal 900 can also include various user interfaces 910 coupled to the base band processor 908. User interfaces 910 can include a keypad, mouse, touch screen, display, ringer, vibrator, audio speaker, microphone, camera and/or other input/output devices.

The base band processor 908 comprises a processor 902. In a software-based implementation of the base band processor 908, the processor 902 may be a software program running on a microprocessor. However, as those skilled in the art will readily appreciate, the processor 902 is not limited to this embodiment, and may be implemented by any means known in the art, including any hardware configuration, software configuration, or combination thereof, which is capable of performing the various functions described herein. The processor 902 can be coupled to memory 912 for the storage of data.

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

What has been described above includes examples of one or more embodiments. It is, of course, not possible to describe every conceivable combination of components or methodologies for purposes of describing these embodiments, but one of ordinary skill in the art may recognize that many further combinations and permutations of such embodiments are possible. Accordingly, the embodiments described herein are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for a mobile device to configure a firewall to reduce unwanted network traffic, comprising:
establishing a network connection with a network firewall; and
communicating with the network firewall to manage network traffic.

2. The method of claim 1, further comprising:
detecting if a passive socket has been created; and
requesting the network firewall to permit flows directed to the passive socket.

3. The method of claim 2, further comprising:
closing a web-server;
destroying the passive socket;
contacting the firewall; and
requesting the firewall to deny flows directed to the passive socket.

4. The method of claim 2, further comprising:
determining whether the passive socket is open or closed; and
allowing further communication directed to the passive socket if the socket is open.

5. The method of claim 2, further comprising:
determining whether the passive socket is open or closed; and
automatically revoking the request to the firewall to permit flows directed to the passive socket.

6. A method for a host to automatically recover from a broken session, comprising:
requesting a remote firewall to allow transit of packets directed to at least one open socket;
detecting a broken session;
revoking the packet request directed to at least one open socket;
reestablishing a new session; and
requesting transit of desired flows.

7. The method of claim 6, requesting packets directed to at least one open socket further comprising generating a list of current open sockets.

8. The method of claim 6, requesting transit of desired flows further comprising regenerating the list of open sockets.

9. The method of claim 6, detecting a broken session further comprising ascertaining that the at least one open socket is closed.

10.. The method of claim 6, detecting a broken session further comprising observing a lack of traffic from a peer device.

11. A mobile device for configuring a network firewall, comprising:
a processor that analyzes information related to configuring a firewall to reduce traffic; and
a memory operatively connected to the processor.

12. The mobile device of claim 11, further comprising:
an establisher that establishes a communication with an external source; and
a designator that designates parameters associated with a packet received from the external source and communicates the parameters to a firewall.

13. The mobile device of claim 12, the external source is a web-server.

14. The mobile device of claim 12, the parameter is an open passive socket.

15. The mobile device of claim 12, further comprising an invalidator that requests revocation of transit for the at least one parameter.

16. The mobile device of claim 11, further comprising:
a transmitter that communicates to a firewall at least one policy update; and
a receiver that receives an acknowledgement or denial of the policy from the firewall.

17. An apparatus for use in mobile device for reducing network traffic, comprising:
means for detecting at least one firewall;
means for communicating with the at least one firewall; and
means for dynamically updating a policy associated with the at least one firewall.

18. The apparatus of claim 17, further comprising means for inspecting a list of passive sockets.

19. The apparatus of claim 17, further comprising means for specifying desired incoming flows.

20. A computer readable medium for use in a mobile device, said medium having computer-executable instructions for:
establishing a network connection;
detecting a passive socket associated with the established network connection;
contacting a firewall; and
requesting the firewall to allow flows directed to the passive socket.

21. The computer readable medium of claim 20, further comprising computer-executable instructions for:
terminating the network connection;
destroying the passive socket;
contacting the firewall; and
requesting the firewall to deny flows directed to the destroyed passive socket.

22. The computer readable medium of claim 20, further comprising computer-executable instructions for:
determining if the passive socket is open or closed; and
allowing further communication directed to the passive socket if the socket is open.

23. The computer readable medium of claim 20, further comprising computer-executable instructions for:
determining whether the passive socket is open or closed; and
automatically revoking the request to the firewall to permit flows directed to the passive socket if the passive socket is closed.

24. A processor for use in a mobile device to execute instructions for dynamically updating a firewall policy, the instructions comprising:
detecting at least one firewall;
communicating with the at least one firewall; and
dynamically updating a policy associated with the at least one firewall.

25. The processor of claim 24, the instructions further comprising:
automatically revoking the policy at substantially the same time as a session is broken.

26. A handset that dynamically configures a firewall, comprising:
an initializer that establishes a session with a firewall;
a designator that designates at least one flow and communicates the at least one flow to a firewall; and
an invalidator that can revoke transit of the least one flow.

27. The handset of claim 26, the designator specifies a parameter associated with at least one packet.

28. The handset of claim 27, the parameter comprising one of an exact value, a value list, a value range, and an open socket.

29. The handset of claim 27, the invalidator revokes transit of the at least one packet.

30. The handset of claim 26, the designator requests a packet from one or more senders.

31. The handset of claim 30, the invalidator rescinds the request for a packet from the one or more senders.

32. The handset of claim 26, the invalidator revokes the transit automatically based on at least one packet parameter.

33. The handset of claim 26, the invalidator revokes the transit based on a user input.
